(19) United States
(12) Patent Application Publication
(10) Pub. No.: US 2005/0095543 A1
(43) Pub. Date: May 5, 2005

(54) Evaporator arrangement for generating a hydrocarbon/steam mixture that can be decomposed in a reformer for producing hydrogen

(76) Inventors: Andreas Kaupert, Ulm (DE); Gunter Eberspach, Wolfschlugen (DE)

Correspondence Address: MCGLEW & TUTTLE, PC, 1 SCARBOROUGH STATION PLAZA, SCARBOROUGH, NY, 10510-0827, US

(21) Appl. No.: 10/945,039

(22) Filed: Sep. 20, 2004

(30) Foreign Application Priority Data
Oct. 15, 2003 (DE) 103 48 638.0

(51) Int. Cl. F23D 1/00

(52) U.S. Cl. 431/252

(57) ABSTRACT

An evaporator arrangement for generating a hydrocarbon/steam mixture that can be decomposed in a reformer for producing hydrogen comprises an evaporator area, which has a steam-generating means (32, R, 36, 38, 40), a mixing chamber (14), into which steam enters via an inlet opening arrangement (16), as well as a hydrocarbon-evaporating means (24, 28), comprising a porous evaporator medium (24) and a first heating means (28) associated with same.

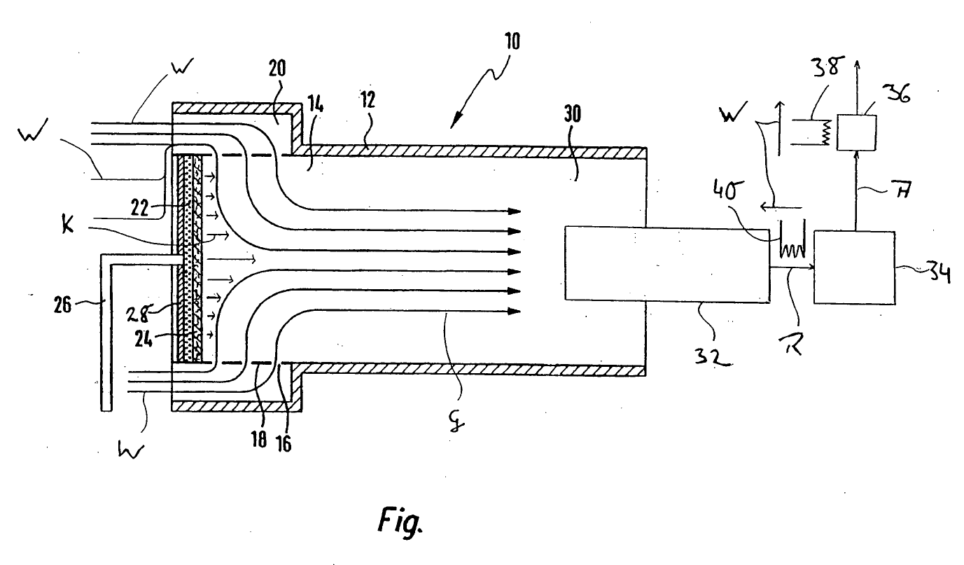

### CROSS REFERENCE TO RELATED APPLICATIONS

This application claims the benefit of priority under 35 U.S.C. §119 of 103 48 638.9 filed Oct. 15, 2003, the entire contents of which are incorporated herein by reference.

### FIELD OF THE INVENTION

The present invention pertains to an evaporator arrangement for generating a hydrocarbon/steam mixture that can be decomposed in a reformer for producing hydrogen.

### BACKGROUND OF THE INVENTION

Reformers are used to split hydrocarbons or materials containing hydrocarbons in a catalytic reaction and to release or produce hydrogen in the process. This hydrogen may be used, for example, in fuel cells to generate electric energy or in an exhaust gas guiding system of an internal combustion engine for treating the exhaust gas.

### SUMMARY OF THE INVENTION

The object of the present invention is to propose an evaporator arrangement for generating a hydrocarbon/steam mixture that can be decomposed in a reformer for producing hydrogen, which can provide a mixture suitable for producing a reformate with a simple design and in a reliable manner.

This object is accomplished according to the present invention by an evaporator arrangement for generating a hydrocarbon/steam mixture that can be decomposed in a reformer for producing hydrogen, comprising an evaporator area, which comprises:
a steam-generating means,
a mixing chamber, into which steam enters via an inlet opening arrangement, and
a hydrocarbon evaporating means, comprising a porous evaporator medium and, associated therewith, a first heating means.

By providing a heating means provided or designed especially for evaporating hydrocarbons, it can be ensured that the hydrocarbon, which is necessary for producing the reformate, will also be reliably evaporated at comparatively low ambient temperatures and can be mixed with the steam introduced into the mixing chamber to form the mixture to be fed into a reformer.

Provisions may be made, for example, in the arrangement according to the present invention for the hydrocarbon-evaporating means to be arranged in a bottom area of the mixing chamber. Furthermore, it is possible for the inlet opening arrangement to be provided in a wall area surrounding the mixing chamber.

The first heating means can be preferably operated electrically.

According to another advantageous aspect, a second heating means may be provided for heating a wall surrounding the mixing chamber and/or a wall adjoining the mixing chamber in the direction of flow.

Since very high temperatures occur in different areas, for example, in a fuel cell or even in an exhaust gas guiding system of an internal combustion chamber, it is proposed according to another aspect of the present invention that the second heating means comprise a heat exchanger arrangement through which heated fluid can flow. The heated fluid mentioned can then be heated in the areas in which high temperatures occur, for example, due to the fact that exothermic reactions take place.

As an alternative or in addition, it is also possible for the second heating means to comprise a heating element that can be operated electrically.

Furthermore, provisions may be made in the evaporator arrangement according to the present invention for the steam generating arrangement to comprise a heat source and a heat exchanger arrangement for transferring heat from the heat source to water that is to be evaporated. This heat source may comprise, for example, the reformate generated in a reformer arrangement. Since an exothermic reaction, in which comparatively high temperatures develop, does generally occur during a catalytic reaction in a reformer for converting a hydrocarbon/steam mixture, the reformate leaving such a reformer likewise has a comparatively high temperature, which can be used by a corresponding heat transfer to heat water in order to generate the steam to be introduced into the evaporator arrangement.

However, since the generation of reformate can begin only when a mixture of hydrocarbon vapor and steam, which mixture is used for that purpose as a starting material, is already present, it is proposed according to another aspect of the present invention that the heat source comprise a burner arrangement. Consequently, the heat with which water can be converted into steam can be provided in this burner arrangement at least during a start phase of the reforming process. Provisions may be made, for example, for the burner arrangement to be designed to receive and burn waste gases that leave a fuel cell and contain residual hydrogen and/or liquid or gaseous fuel. The residual reformate or waste gas leaving the fuel cell, which still contains a certain percentage of residual hydrogen, can thus be efficiently utilized for generating heat with the reforming process already running and with the fuel cell being operated with the use of the hydrogen generated in the process.

Furthermore, the present invention pertains to a reformer system for producing hydrogen from a hydrocarbon/steam mixture, comprising an evaporator arrangement according to the present invention.

Since comparatively high temperatures of, e.g., higher than 300° C. are necessary for starting the catalytic reaction (steam reforming), which takes place, in general, in a reformer, it is proposed according to another aspect of the present invention that a heating arrangement designed to preheat a reformer and/or a fuel cell is provided. This heating arrangement may comprise, for example, the above-mentioned burner arrangement, which can then also provide the heat necessary for evaporating water for generating steam or part of this heat during the operation of the overall system.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

The only FIGURE is a schematic longitudinal section of an evaporator arrangement according to the present invention.

### DESCRIPTION OF THE PREFERRED EMBODIMENT

An evaporator arrangement according to the present invention is designated in the FIGURE, in general, by the reference number 10. The evaporator arrangement 10 comprises an elongated, tubular housing arrangement 12, in which a mixture G of evaporated fuel K, for example, diesel fuel or gasoline, and steam W is formed, as will be described below. It is also possible to use nonfossil fuels, e.g., biodiesel, here. A mixing chamber 14, into which the steam W is fed from a radially outer, annular space 20 via a plurality of inlet openings 16 in the outer circumferential wall 18, is provided for this purpose in the housing 12. A porous evaporator medium 24, which may be formed, for example, by a nonwoven material or another fabric or a mat-like material, foamed ceramic or the like, is provided at a bottom area 22 of the mixing chamber 14. A fuel feed line 26 leads through the bottom area 22 and introduces the fuel to be evaporated into the porous evaporator medium 24. The fuel/steam mixture G, which is formed in the mixing chamber 14 by the steam feed, on the one hand, and the evaporation of the fuel, on the other hand, and which can be considered to be a hydrocarbon/steam mixture, leaves the mixing chamber 14 and enters a volume area 30 in which the catalytic material of a reformer 32 indicated schematically, which said catalytic material is not shown in the FIGURE, may be arranged. The mixture G leaving the mixing chamber 14 and flowing toward the catalyst is split at the catalyst by a catalytic reaction in order to obtain a reformate containing hydrogen. This hydrogen can then be used further, e.g., in a fuel cell 34 to generate electric energy or in an exhaust gas guiding system of an internal combustion engine for exhaust gas cleaning.

While electric energy is generated, the reformate R is then converted in the fuel cell 34, but the waste gases A, which leave the fuel cell 34 and which can also be called a residual reformate, will still contain a certain percentage of residual hydrogen. In order to make it possible to operate the overall system as efficiently as possible, these waste gases are sent to a burner 36, where they are burned. The heat generated in the process is received in a heat exchanger arrangement 38 indicated only schematically and is further utilized as will be described below. The burner arrangement 36 may, furthermore, be designed to receive another fuel, i.e., for example, liquid fossil fuel, e.g., diesel oil or gasoline, or gaseous fuel, in order to burn it to generate heat. This characteristic of the burner arrangement 36 is of significance especially because comparatively high temperatures above 300° C. to 600° C. may be necessary in the area of the reformer 32 or also of the fuel cell 34 for starting the reactions taking place there. This means that it is first necessary during a start phase or before a start phase to bring, e.g., the reformer 32 to a sufficiently high temperature. This can be done with the use of the burner arrangement 36 such that the said burner arrangement first burns fuel fed into it and the heat generated in the process is used to preheat the reformer 32 or the catalytic material contained in it. This can be done by introducing the very hot gases leaving the burner arrangement 36 into the mixing chamber 14 and passing them through the reformer 32 and optionally also the fuel cell 34 in order provide a very intensive primary-side heating of the catalytic material. It is also possible to have the combustion waste gases of the burner 36 flow around the reformer 32 and/or the fuel cell 34 in order to provide the desired heating thereby. Furthermore, it is possible to transfer the heat generated in the burner arrangement 36 in the heat exchanger arrangement 38 to a heat carrier medium, for example, water or the like, in order to thus condition the reformer 36 or the fuel cell 34 for starting the operation in case of a corresponding flow through the reformer 36 or the fuel cell 34. The reaction taking place during the reforming process is an endothermic reaction, i.e., a reaction whose maintenance requires the supply of energy, for example, in the form of thermal energy. This means that heat must be supplied in this case to the reformer 32 even during the reforming process to maintain this process in order to maintain the necessary temperature of up to 600° C. This may also happen with the use of the burner arrangement 36, which will then burn the waste gases A of the fuel cell 34 during the reforming process and, for example, also during the operation of the fuel cell 34 in order to send the heat generated in the process to the reformer 32. It shall be mentioned here that the burner arrangement 36 may also comprise a catalytic burner area in order to burn the waste gases A of the fuel cell 34 and the residual hydrogen contained therein in a catalytic reaction especially during the combustion of the waste gases A of the fuel cell 34 and to utilize the heat generated in the process. Such a catalytic burner area may then be coupled with a burner area in which other fuels, e.g., liquid or gaseous fossil or nonfossil, hydrocarbon-containing fuels are burned.

If the fuel cell 34 and the reformer 32 are at the desired temperature, the reforming process can be started. As was mentioned above, liquid fuel is introduced for this purpose into the evaporator medium 24 via the fuel feed line 26. To intensify or support the evaporation of this fuel as a hydrocarbon vapor K, a heating means 28 is associated with the evaporator medium 24. This can preferably be operated electrically and comprises, for example, a.heating coil or the like, which is located on the side of the bottom area 22 facing away from the mixing chamber 14 in the example being shown. It is, of course, also possible to position this heating means 28 between the bottom area 22 and the porous evaporator medium 24 in order to attain an even more efficient introduction of heat into this porous evaporator medium. Consequently, the temperature can be increased in the area of the porous evaporator medium 24 by exciting the heating means 28, so that the evaporation of the fuel fed via the line 26 will take place there in an increased amount.

Together with the hydrocarbon vapor K, which enters the mixing chamber 14 in an increased amount due to the excitation of the heating means 28, steam W is introduced into the mixing chamber 14, as was explained above. It may be ensured before the introduction into the mixing chamber 14 that the steam W fed in at a comparatively high temperature will flow around the bottom area 22 on its side facing away from the mixing chamber 14, so that the heat being transported in the steam W can be additionally used to heat the bottom area 22 and consequently the evaporator medium 24, and the heat output to be provided for evaporating the fuel can be reduced. However, it should be ensured that to avoid the excessively premature evaporation of the fuel, the steam W cannot flow around the fuel feed line 26. For example, insulation or the like may be provided here for this fuel feed line 26.

The mixture G of fuel vapor or hydrocarbon vapor K and steam W which is formed in the mixing chamber 14 flows in the direction of the thermally already conditioned reformer 32 and is then converted into the reformate R by the reaction taking place in the reformer 32. Since this reaction takes place at comparatively high temperatures and contributes to the development of correspondingly high temperatures in the area of the reformer 32, the reformate R, which leaves the reformer 32 in the direction of the fuel cell 34, will also have a very high temperature. This heat thus transported in the reformate can be used to transfer heat to water as an alternative or in addition to the heat exchanger arrangement 38 in another heat exchanger arrangement 40 in order to evaporate this water and to make it possible to introduce this water as steam W into the mixing chamber 14. However, as was already described above, it is also possible to burn the waste gas A leaving the fuel cell 34 in the direction of the burner arrangement 36 and still carrying residual hydrogen in the burner 36 to generate heat in order to also use this heat or at least a part of it in the heat exchanger arrangement 38 to evaporate water. This is possible especially because no additional heating of the reformer 32 is necessary, in general, during this phase of the reformate generation. Should this nevertheless be necessary, it would be possible, for example, to transfer the heat made available in the heat exchanger arrangement 40 to the water to generate the steam W, while the heat made available in the heat exchanger arrangement or the heat being transported in the waste gases leaving the burner arrangement 36 can be used to heat the reformer 32 and/or the fuel cell 34.

In order to make it possible to further increase the efficiency of the overall system during the reforming operation or even during the fuel cell operation, it may be advantageous to branch off part of the reformate R generated in the reformer 32 before it would be introduced into the fuel cell 34 and to introduce this branched-off portion into the mixing chamber 14, so that the mixture G fed to the reformer 32 will already contain a certain percentage of reformate. It can thus be ensured, especially if this reformate had first been cooled in the heat exchanger arrangement 40, that the steam being transported in the reformate and not converted into hydrogen during the reforming reaction is again fed into the reformer 32 and the efficiency can thus be increased during the hydrogen generation. Part of the waste gases A leaving the fuel cell 34 or of the waste gases leaving the burner arrangement 36 may also be introduced into the mixing chamber 14 for being mixed with the steam W and the hydrocarbon vapor K.

It shall be pointed out that the system shown in the FIGURE may be varied in different areas. Instead of the burner arrangement 36, which can be switched over between the waste gases A and another fuel, for example, a fossil fuel, or in addition to this burner arrangement 36 receiving the waste gases A, it is possible to provide another burner, which will receive, for example, fossil or gaseous fuel to heat the reformer 32 in order to make it possible to provide the necessary temperatures by combustion. It would also be possible, in principle, to associate the reformer 32 or the catalytic material thereof with an electrically heatable heating means in order to make it possible to bring the catalytic material to the desired temperature especially during the start phase.

While a specific embodiment of the invention has been shown and described in detail to illustrate the application of the principles of the invention, it will be understood that the invention may be embodied otherwise without departing from such principles.

1. An evaporator arrangement for generating a hydrocarbon/steam mixture that can be decomposed in a reformer to produce hydrogen, the arrangement comprising an evaporator area, including:
a steam generating means;
a mixing chamber into which steam enters via an inlet opening arrangement;
a hydrocarbon evaporating means comprising a first heating device and a porous evaporator medium associated with said first heating device.

2. An evaporator arrangement in accordance with claim 1, wherein said hydrocarbon evaporating means is arranged in a bottom area of said mixing chamber.

3. An evaporator arrangement in accordance with claim 1, wherein said inlet opening arrangement is formed in a wall area surrounding said mixing chamber.

4. An evaporator arrangement in accordance with claim 1, wherein said first heating means can be operated electrically.

5. An evaporator arrangement in accordance with claim 1, further comprising a second heating means for heating a wall surrounding said mixing chamber and/or for heating a wall adjoining said mixing chamber in the direction of flow.

6. An evaporator arrangement in accordance with claim 5, wherein said second heating means comprises a heat exchanger arrangement through which heated fluid can flow and/or a heating element that can be operated electrically.

7. An evaporator arrangement in accordance with claim 1, wherein said steam generating arrangement comprises a heat source and a heat exchanger arrangement for transferring heat from said heat source to water to be evaporated.

8. An evaporator arrangement in accordance with claim 7, further comprising a reformer arrangement wherein said heat source comprises a reformate generated in said reformer arrangement.

9. An evaporator arrangement in accordance with claim 7, wherein said heat source comprises a burner arrangement.

10. An evaporator arrangement in accordance with claim 9, wherein said burner arrangement receives and burns waste gases leaving said fuel cell and containing residual hydrogen and/or liquid or gaseous fuel.

11. A reformer system for producing hydrogen from a hydrocarbon/steam mixture, comprising:
an evaporator area, including a steam generating means, a mixing chamber into which steam enters via an inlet opening arrangement, a hydrocarbon evaporating means comprising a first heating device and a porous evaporator medium associated with said first heating device.

12. A reformer system in accordance with claim 11, further comprising:
a reformer and/or a fuel cell; and
a heating arrangement to preheat said reformer and/or said fuel cell.

13. A reformer system in accordance with claim 12, wherein said heating arrangement comprises a burner arrangement.
